(19) United States
(12) Patent Application Publication
(10) Pub. No.: US 2021/0018587 A1
(43) Pub. Date: Jan. 21, 2021

(54) SYSTEM AND METHOD FOR LOCATING A MOBILITY-AS-A-SERVICE ASSET

(71) Applicant: c/o Toyota Motor North America, Inc., Plano, TX (US)

(72) Inventors: Randall M. Harris, Dallas, TX (US); Alyssa M. Pipe, Plano, TX (US); Gagandeep Singh Saini, Plano, TX (US); Stephen Paul McFarland, JR., Allen, TX (US); Armin Lange, Addison, TX (US); Felipe G. Salles, Garland, TX (US); Michael B. Murray, Dallas, TX (US)

(21) Appl. No.: 16/512,893

(22) Filed: Jul. 16, 2019

(51) Int. Cl. G01S 5/02; H04W 64/00; G06T 11/20

(52) U.S. Cl. CPC G01S 5/0289; G06T 11/206; H04W 64/003

(57) ABSTRACT

A Mobility-as-a-Service (“MaaS”) system and related method for locating at least one MaaS asset includes one or more processors and a memory device in communication with the one or more processors. The memory device stores information receiving module, a location module, and a map generating module. The map generating module includes instructions that when executed by the one or more processors cause the one or more processors to receive information from at least one secondary asset having an electronic sensing device. The location module includes instructions that when executed by the one or more processors cause the one or more processors to determine a location of the MaaS asset based on the information from the secondary asset. The map generating module includes instructions that when executed by the one or more processors cause the one or more processors to generate an electronic three-dimensional map of an area surrounding the location of the MaaS asset and place a MaaS asset indicator on the electronic three-dimensional map.

### TECHNICAL FIELD

The subject matter described herein relates, in general, to a system and method for locating at least one Mobility-as-a-Service (“MaaS”) asset.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

MaaS providers that allow users to operate their vehicles, sometimes referred to as MaaS assets, in exchange for a fee are routinely plagued with the issue of identifying the location of a MaaS asset after it is no longer being used by a user. This problem is more common with less expensive MaaS assets, such as bicycles and scooters, that are routinely left at a location that is most convenient for the user but is not necessarily suitable for the MaaS provider and subsequent users. Presently, global navigation satellite systems (“GNSS”), such as GPS and other similar systems, attempt to provide location information about MaaS assets. However, these systems may only function within limited contexts such as outdoor locations with unobstructed views of the sky. Therefore, precise locations of such assets can often be unavailable, leading to difficulties in returning the MaaS asset or a subsequent user locating a MaaS asset for use.

### SUMMARY

This section generally summarizes the disclosure and is not a comprehensive explanation of its full scope or all its features.

In one embodiment, a MaaS system for locating at least one MaaS asset includes one or more processors and a memory device in communication with the one or more processors. The memory device stores information receiving module, a location module, and a map generating module. The map generating module includes instructions that when executed by the one or more processors cause the one or more processors to receive information from at least one secondary asset having an electronic sensing device. The location module includes instructions that when executed by the one or more processors cause the one or more processors to determine a location of the MaaS asset based on the information from the secondary asset. The map generating module includes instructions that when executed by the one or more processors cause the one or more processors to generate a three-dimensional electronic map of an area surrounding the location of the MaaS asset and place a MaaS asset indicator on the electronic three-dimensional map.

In another embodiment, a method for locating at least one MaaS asset includes the steps of receiving information from at least one secondary asset having an electronic sensing device, determining a location of the MaaS asset based on the information from the secondary asset, the location of the MaaS asset being a three-dimensional coordinate, generating an electronic three-dimensional map of an area surrounding the location of the MaaS asset, and placing a MaaS asset indicator on the electronic three-dimensional map, the MaaS asset indicator indicating the location of the MaaS asset.

In yet another embodiment, a non-transitory computer-readable medium for locating at least one MaaS asset includes instructions that when executed by one or more processors cause the one or more processors to receive via a network access device information from at least one secondary asset having an electronic sensing device, determine a location of the MaaS asset based on the information from the secondary asset, the location of the MaaS asset being a three-dimensional coordinate, generate an electronic three-dimensional map of an area surrounding the location of the MaaS asset, and place a MaaS asset indicator on the electronic three-dimensional map, the MaaS asset indicator indicating the location of the MaaS asset.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a general overview of a MaaS system for locating at least one MaaS asset;

FIG. 2 illustrates a block diagram of a general overview of a MaaS system for locating at least one MaaS asset when the MaaS asset is located in a parking structure;

FIG. 3 is a more detailed block diagram of a MaaS system for locating at least one MaaS asset; and

FIG. 4 illustrates a method for locating at least one MaaS asset.

### DETAILED DESCRIPTION

The present disclosure describes examples of a MaaS system that has the ability to identify the location of MaaS assets. The MaaS system receives information from other MaaS assets that are equipped with sensing devices, such as cameras or RFID readers. These other MaaS assets collect information regarding missing MaaS assets. This collected information is transmitted to the MaaS system, which then is able to determine the location of any sensed MaaS assets and generate a three-dimensional map indicating the location of these sensed MaaS assets.

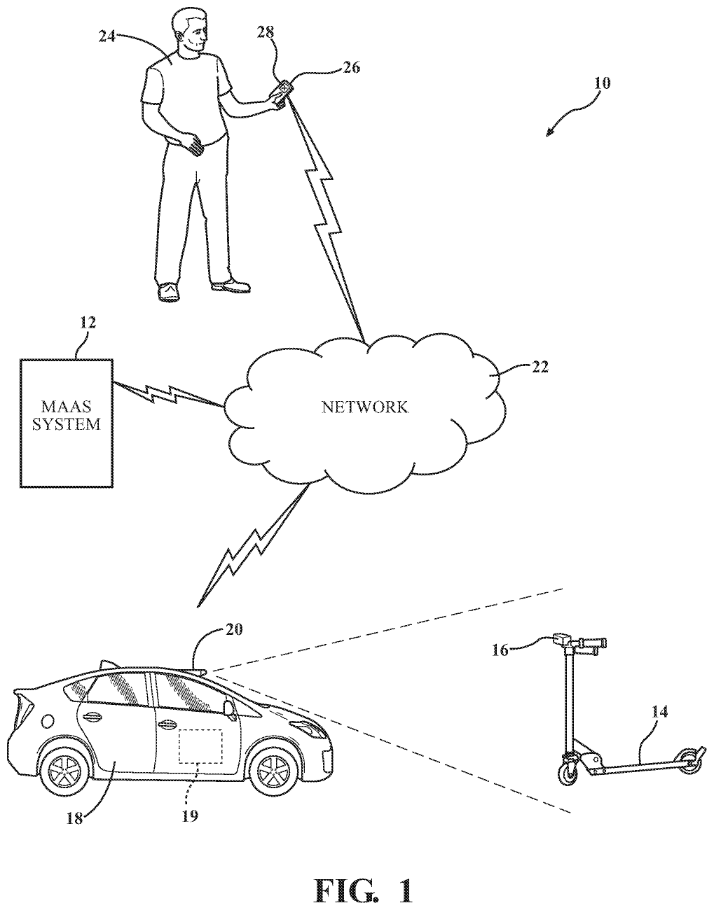

Referring to FIG. 1, a system 10 incorporating the MaaS system 12 is shown. The system 10 is essentially an example of one implementation of the MaaS system 12 for determining the location of MaaS assets, especially MaaS assets that have gone missing. The system 10, in this example, includes a MaaS asset 14 that is in the form of a scooter. It should be understood that the MaaS asset 14 may be any type of MaaS asset that allows for the transportation of persons or items from one location to another. As such, the MaaS asset 14 may be a scooter, as shown, but could be an automobile, truck, tractor-trailer, sport utility vehicle, heavy-duty truck, bicycle, motorcycle, tractor, military vehicle, mining vehicle, and the like. Furthermore, the MaaS asset 14 may not be limited to land-based vehicles but could also include aircraft and watercraft as well.

The MaaS asset 14 includes an identifier 16. The identifier 16 may be a visual identifier such as an alphanumeric code, a barcode, and the like. The identifier 16 may also be an electronic identifier, such as an RFID tag, near field communication device that includes the identifier, or one or more vehicle systems or subsystems that are able to provide the identifier, and the like. It should be understood that the identifier 16 may be any type of identifier that provides some form of identification of the MaaS asset 14.

Also shown is a secondary MaaS asset 18 having a MaaS detection system 19. In this example, the secondary MaaS asset 18 is an automobile. However, like the MaaS asset 14, the secondary MaaS asset 18 may be any type of vehicle capable of transporting persons or items from one location to another. Furthermore, it should be understood that the secondary MaaS asset 18 may be a dedicated device that does not transport persons or goods from one location to another, but rather travels through the environment and sensing any MaaS assets, such as MaaS asset 14.

Additionally, the secondary MaaS asset having the detection system 19 may be incorporated within a fixed structure, such as a parking structure and the like. As such, the detection system 19 could then sense the identifier 16 of the MaaS asset 14 and report that identity and the location of the MaaS asset 14. In this example, the secondary MaaS asset would not be a vehicle at all and would be integrated into a structure, such as a parking structure.

The secondary MaaS asset 18 may be equipped with a sensing device 20. In this example, the sensing device 20 is in the form of a camera that is capable of sensing the identifier 16 of the MaaS asset 14. The MaaS asset 18, as will be described in greater detail later in this description, is able to sense the identifier 16 of the MaaS asset 14 and provide information to the MaaS system 12 regarding the identifier 16 of the MaaS asset 14 and the location of the MaaS asset 14. The location of the MaaS asset 14 may be based on the location of the secondary MaaS asset 18.

The information from the secondary MaaS asset 18 is provided to the MaaS system 12 via a network 22 that may be a distributed network, such as the Internet. The MaaS system 12 receives the information from the secondary MaaS asset 18 and is able to determine the location of the MaaS asset 14. Thereafter, the MaaS system 12 may generate a three-dimensional map with an indicator indicating the location of the MaaS asset 14. The location of the MaaS asset 14 may be provided to a user 24 that is using a device 26, such as a mobile phone or tablet. The device 26 may then display the three-dimensional map 28 containing the location of the MaaS asset 14 to the user 24 such that the user 24 can find the MaaS asset 14 and utilize the MaaS asset 14.

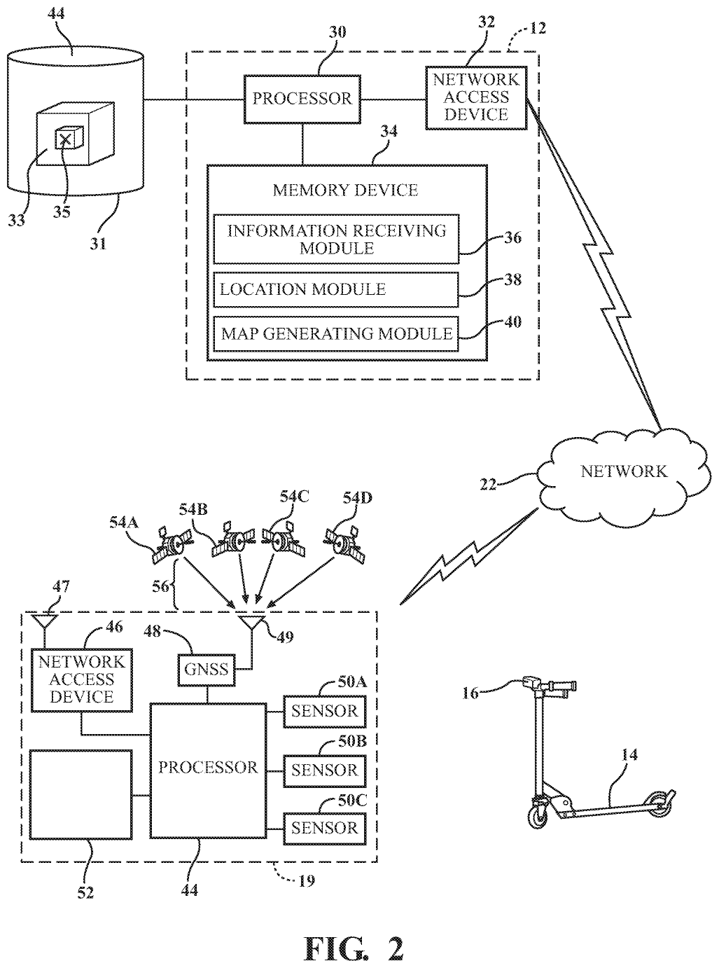

Referring to FIG. 2, a more detailed illustration of the MaaS system 12 and the MaaS detection system 19 is shown. Here, the MaaS system 12 may include one or more processors 30. In addition, the MaaS system 12 may also include a database 31, a network access device 32, and/or a memory device 34 all of which are in communication with the one or more processors 30.

The database 31 may include one or more storage devices that store information generated or used by the one or more processors 30. The database 31 may utilize storage devices that could include solid-state storage devices, optical storage devices, magnetic storage devices, and the like. In this example, the database 31 is located separate and apart from the MaaS system 12. However, it should be understood that the database 31 may be integrated within the MaaS system 12 and may be further integrated within the memory device 34 of the MaaS system 12. In this example, the database 31 stores a three-dimensional map 33 that contains an indicator 35 indicating the location of one or more MaaS assets, such as the MaaS asset 14.

The network access device 32 may be an electronic device, such as a circuit, that connects the one or more processors 30 to the network 22, such as the Internet. The network access device 32 may include any equipment required to make a connection to a wide area network from a local area network. As such, the network access device 32 acts as a conduit that allows for the communication of the one or more processors 30 to communicate with a number of different devices, such as the MaaS detection system 19 and/or the device 26 of FIG. 1.

The memory device 34 may be any type of memory device capable of storing information that can be utilized by the one or more processors 30. As such, the memory device 34 may be a solid-state memory device, magnetic memory device, optical memory device, and the like. In this example, the memory device 34 is separate from the one or more processors 30, but it should be understood that the memory device 34 may be incorporated within any of the one or more processors 30.

The memory device 34 may store one or more modules that when executed by the one or more processors 30 cause the one or more processors 30 to perform any one of a number of different methods disclosed in this disclosure. In this example, the memory device 34 includes an information receiving module 36, a location module 38, and a map generating module 40.

The information receiving module 36 may include instructions that when executed by the one or more processors 30 cause the one or more processors 30 to receive information from at least one secondary asset having an electronic sensing device. For example, the secondary asset may be the secondary MaaS asset 18 having the detection system 19. The information from the secondary MaaS asset 18 may include a location of the secondary MaaS asset 18 and an identifier, such as identifier 16, of a MaaS asset, such as MaaS asset 14, sensed by the electronic sensing device of the secondary MaaS asset 18.

The location module 38 may include instructions that when executed by the one or more processors 30 cause the one or more processors 30 to determine a location of the MaaS asset 14 based on the information from the secondary asset, such as MaaS asset 18. The location of the MaaS asset 18 may be a three-dimensional coordinate that may include latitude, longitude, and/or altitude.

The map generating module 40 may include instructions that when executed by the one or more processors 30 cause the one or more processors 30 to generate a location description of the MaaS asset, the location description including a location of the MaaS asset in a three dimensional space. In one example, the map generating module may generate an electronic three-dimensional map of an area surrounding the location of the MaaS asset 14 and place a MaaS asset indicator on the electronic three-dimensional map, the MaaS asset indicator indicating the location of the MaaS asset. The three-dimensional map generated by the map generating module 40 may be stored on the database 31 as map 33 having an indicator 35, the indicator 35 indicating the location of the MaaS asset 14 on the map 33. The map 33 containing the indicator 35 may be communicated to another device, such as device 26 of FIG. 1.

When transmitted to the device 26, the user 24 of the device 26 will then be able to determine the location of the MaaS asset 14 by looking at the three-dimensional map and the indicator indicating the position of the MaaS asset 14 on the three-dimensional map. Furthermore, it should be understood that the transmission of the map and/or the indicator from the MaaS system 12 to another device, such as device 26, may include the transmission of data, wherein the device 26 then reconstructs the map and the indicator on the device 26 and displays the map and/or the indicator to the user 24.

Additionally, it should be understood that the MaaS system 12 may be incorporated within the detection system 19 and/or the device 26. As such, the detection system 19 and/or the device 26 would also contain a processor and a memory device that includes the information receiving module 36, the location module 38, and the map generating module 40. The detection system 19 and/or the device 26 would perform any of the operations performed by the MaaS system 12, such as receiving information from the secondary MaaS asset, determine the location of the MaaS asset and then generating a three-dimensional map having an indicator indicating the position of the MaaS asset on a three-dimensional map.

Further, the modules 36, 38, and/or 40 could be a component of the one or more processors 30 or one or more of the modules 36, 38, and/or 40 can be executed on and/or distributed among other processing systems to which the one or more processors 30 are operatively connected. For example, the detection system 19 and/or the device 26 could also execute and/or be included in the distribution among other processing systems to which the one or more processors 30 are operatively connected.

The detection system 19 may include one or more processors 44 in communication with a network access device 46, a GNSS system 48, sensors 50A-50C, and a memory device 52. The network access device 46 allows the one or more processors 44 of the detection system 19 to communicate with the network 22, such as the Internet. As such, the network access device 46 may be any one of a number of different components that allow the transmission of information to the network 22 and therefore to other electronic systems and subsystems connected to the network 22. These electronic systems and subsystems could include the MaaS system 12 and/or the device 26 of FIG. 1. The network access device 46 may be connected to an antenna 47 that allows for the wireless transmission and reception of data from system 19.

The GNSS system 48 may be a satellite navigation system that provides autonomous geo-spatial positioning with global coverage. The GNSS system 48 may include any one of a number of different GNSS systems, such as GPS, GLONASS, Galileo, Beidou or other regional systems. The GNSS system 48 may be connected to an antenna 49 that is capable of receiving one or more signals 56 from one or more satellites 54A-54D. Based on the one or more signals 56 from one or more satellites 54A-54D, the GNSS system 48 is able to determine the relative location of the detection system 19 (and therefore the secondary MaaS asset 18 in which the detection system 19 is installed). This relative location may be in the form of a coordinate system that may indicate the latitude, longitude, and/or altitude of the detection system 19 and/or MaaS asset that has the GNSS system 48 installed within.

As such, the GNSS system 48 allows for one or more processors 44 to determine the relative location of the system 19, and then relay this information to the MaaS system 12 and/or the device 26 via the network access device 46.

The sensors 50A-50C may include any one of a number of different sensors that are able to sense an identifier of a MaaS asset, such as identifier 16 of the MaaS asset 14. In one example, the sensor 50A may be a camera system capable of visually detecting and sensing the identifier 16, especially when the identifier 16 is a visual identifier, such as a barcode or alphanumeric plate. Additionally or alternatively, the sensor 50A could also include a light detection and ranging system.

The sensor 50B may be an RFID reader, that can receive information from RFID tags. As such, if the identifier 16 of the MaaS asset 14 is an RFID tag, the sensor 50B can receive information including identifying information from the identifier 16. Additionally or alternatively, the sensor 50B may be an electronic reader that can access one or more electronic devices of the MaaS asset 14. In this case, the identifier 16 would be one or more electronic devices of the MaaS asset 14. These one or more electronic devices could include identifying information regarding the MaaS asset 14. The sensor 50B would be able to request and receive information from the one or more electronic devices of the MaaS asset 14 so as to determine the identity of the MaaS asset 14B.

The sensor 50C may be an environmental sensor that can detect certain features regarding the environment. For example, the sensor 50C could be a barometric pressure sensor that determines the barometric pressure of the environment in which the detection system 19 operates within. This type of information may be useful when determining the altitude of the secondary MaaS asset 18, which can then be utilized to determine the relative altitude of the MaaS asset 14.

The memory device 52 may include instructions for executing any one of a number of functions including the methods disclosed in this specification. The instructions may be in the form of modules, such as the modules 36, 38, and/or 40 that were previously described. Therefore, the detection system 19 may perform any one of the functions performed by the MaaS system 12 and/or the device 26.

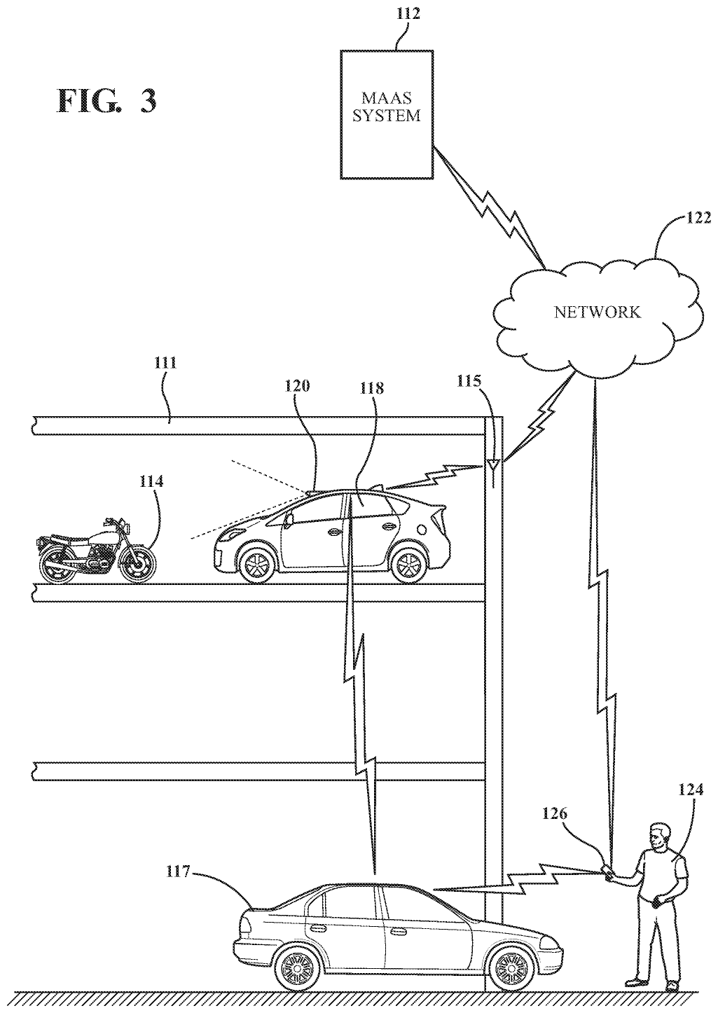

Referring to FIG. 3, brief mention is made regarding how communication may occur between secondary MaaS assets and other systems and subsystems. With regard to the elements shown in FIG. 3, like reference numerals have been utilized to refer to like elements, with the exception that the reference numerals have been increased by 100.

Here, the MaaS asset 114 is in the form of a bicycle. A secondary MaaS asset 118 having a sensing device 120 is located within a parking structure 111. The parking structure 111 may inhibit or prevent the ability of the secondary MaaS asset 118 to communicate with the network 122, so as to relay information regarding the location of the MaaS asset 114. One solution to this problem could include utilizing a mesh network.

A mesh network may be a local network topology in which the infrastructure nodes connect directly, dynamically, and non-hierarchically to as many other nodes as possible and cooperate with one another to efficiently route data. This lack of dependency on one node allows for every node to participate in the relay of information. Mesh networks dynamically self-organize and self-configure, which can reduce installation overhead. The ability to self-configure enables dynamic distribution of workloads, particularly in the event that a few nodes should fail and/or be located in areas that prevent or inhibit the transmission of data, such as the parking structure 111. The mesh network may utilize dedicated short-range communications (“DSRC”), which is an open source protocol for wireless communication between vehicles and/or infrastructure.

In this example, the secondary MaaS asset 18 has detected the MaaS asset 114 using sensing devices 120. The MaaS asset 118 may wish to relay this information to the MaaS system 12. However, in this situation, the parking structure 111 is preventing the transmission of information from the secondary MaaS asset 118. Utilizing a mesh network, the secondary MaaS asset 118 may be able to communicate with the network 122 by utilizing other devices to form a mesh network. Here, the secondary MaaS asset 118 may utilize a node 115 that is part of the parking structure 111. Information is relayed to the node 115, which then relays information to the network 122 and ultimately the MaaS system 112.

In another example, the secondary MaaS asset 118 may communicate to a vehicle 117. The vehicle 117 may then be able to communicate to a device 126, which may be a mobile device of a user 124. Information is then relayed to the network 122 and ultimately the MaaS system 112.

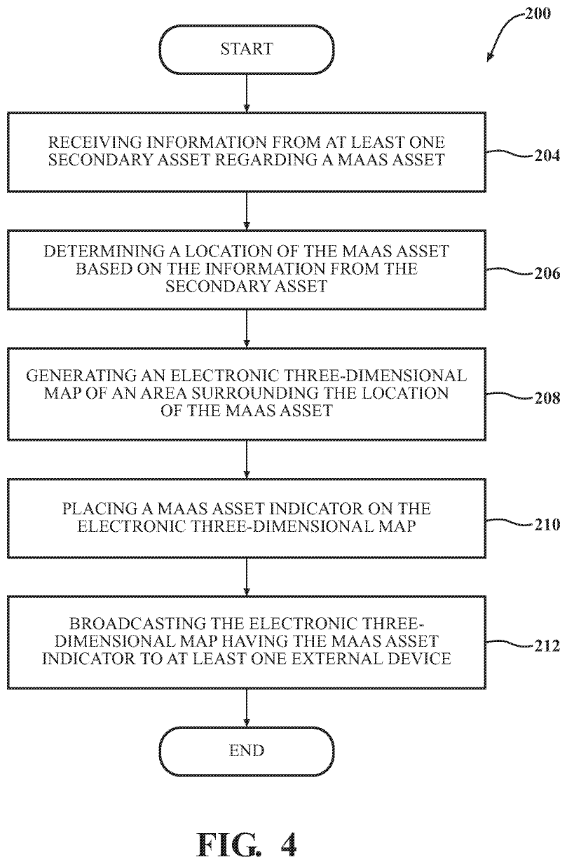

Referring to FIG. 4, a method 200 will be discussed from the perspective of the MaaS system 12 of FIGS. 1-2. While method 200 is discussed in combination with the MaaS system 12, it should be appreciated that the method 200 is not limited to being implemented within the MaaS system 12 but is instead one example of a system that may implement the method 200.

Here, the method begins with step 204, wherein the information receiving module 36 of the MaaS system 12 receives information from the secondary MaaS asset 18 regarding the MaaS asset 14. The information from the secondary MaaS asset 18 could include the identifier of the missing MaaS asset 14 and/or the location of the secondary asset 18.

In step 206, the location module 38 of the MaaS system 12 determines a location of the missing MaaS asset 14 based on information from the secondary asset 18. Here, the location module 38 may be able to determine the general location of the missing MaaS asset 14 by utilizing the location of the secondary asset 18. For example, the location of the missing MaaS asset 14 may be assumed to be the same as the secondary MaaS asset 18 or may be derived from the location of the secondary asset 18.

In step 208, the map generating module 40 of the MaaS system 12 may generate an electronic three-dimensional map 33 of an area surrounding the location of the missing MaaS asset 14. The information utilized to generate the electronic three-dimensional map could include map data of geographic areas from third-party providers. In step 210, the map generating module 40 of the MaaS system 12 may place asset indicator 35 on the electronic three-dimensional map 33 that indicates the general location of the missing MaaS asset 14 on the three-dimensional map 33.

In step 212, the information receiving module 36 broadcast the electronic three-dimensional map 33 having the MaaS asset indicator 35 to at least one external device, such as device 26. By so doing, the user 24 of the device 26 may utilize the three-dimensional map 33 and the indicator 35 to find and utilize the MaaS asset 14.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A Mobility as a Service (“MaaS”) system for locating a first MaaS asset, the MaaS system comprising:
one or more processors;
a memory device in communication with the one or more processors, the memory device storing:
an information receiving module having instructions that when executed by the one or more processors cause the one or more processors to receive information from a second MaaS asset having an electronic sensing device, the information including a location of the second MaaS asset and an identifier of the first MaaS asset sensed by the electronic sensing device of the second MaaS asset, the electronic sensing device being a camera capable of visually detecting and sensing the identifier;
a location module having instructions that when executed by the one or more processors cause the one or more processors to determine a location of the first MaaS asset based on the information from the second MaaS asset, the location of the first MaaS asset being a three-dimensional coordinate;
a map generating module having instructions that when executed by the one or more processors cause the one or more processors to generate a location description of the first MaaS asset, the location description including a location of the first MaaS asset in a three dimensional space; and
wherein the first MaaS asset and the second MaaS asset are vehicles capable of transporting at least one person or cargo from one location to another.

2. The MaaS system, of claim 1, wherein the map generating module further includes instructions that cause the one or more processors to generate an electronic three-dimensional map of an area surrounding the location of the first MaaS asset and place a MaaS asset indicator on the electronic three-dimensional map, the MaaS asset indicator indicating the location of the first MaaS asset.

3. The MaaS system, of claim 2, wherein the information receiving module further includes instructions that cause the one or more processors to broadcast the electronic three-dimensional map having the MaaS asset indicator to at least one external device.

4. The MaaS system, of claim 1, wherein the electronic sensing device further includes an RFID reader.

5. The MaaS system, of claim 4, wherein the identifier is at least one of: a visual tag and a barcode.

6. (canceled)

7. The MaaS system, of claim 1, wherein the information from the second MaaS asset includes at least one of: a GNSS position of the second MaaS asset, a dead reckoned location of the second MaaS asset, and a barometric pressure reading taken by a barometer sensor on the second MaaS asset.

8. The MaaS system, of claim 1, wherein:
the information receiving module further includes instructions that when executed by the one or more processors causes the one or more processors to receive information from a plurality of secondary MaaS assets having the electronic sensing devices; and
the location module further includes instructions that when executed by the one or more processors cause the one or more processors to determine the location of the first MaaS asset based on the information from plurality of secondary MaaS assets, the location of the first MaaS asset being a three-dimensional coordinate.

9. The MaaS system, of claim 1, wherein the information received by one or more processors was transmitted from the second MaaS asset using a mesh network.

10. A method for locating a first Mobility as a Service (“MaaS”) asset, the method comprising the steps of:
receiving information from a second MaaS asset having an electronic sensing device, the information including a location of the second MaaS asset and an identifier of the first MaaS asset sensed by the electronic sensing device of the second asset, the electronic sensing device being a camera capable of visually detecting and sensing the identifier;
determining a location of the first MaaS asset based on the information from the second MaaS asset, the location of the first MaaS asset being a three-dimensional coordinate;
generating an electronic three-dimensional map of an area surrounding the location of the first MaaS asset;
placing a MaaS asset indicator on the electronic three-dimensional map, the MaaS asset indicator indicating the location of the first MaaS asset; and
wherein the first MaaS asset and the second MaaS asset are vehicles capable of transporting at least one person or cargo from one location to another.

11. The method of claim 10, further comprising the step of broadcasting the electronic three-dimensional map having the MaaS asset indicator to at least one external device.

12. The method of claim 10, wherein the electronic sensing device further includes an RFID reader.

13. The method of claim 12, wherein the identifier is at least one of: a visual tag and a barcode.

14. (canceled)

15. The method of claim 10, wherein the information from a second MaaS asset includes at least one of: a GNSS position of the secondary asset, a dead reckoned location of the second MaaS asset, and a barometric pressure reading taken by a barometer sensor on the second MaaS asset.

16. The method of claim 10, further comprising the steps of:
receiving information from a plurality of secondary MaaS assets having the electronic sensing devices; and
determining the location of the MaaS asset based on the information from plurality of secondary MaaS assets, the location of the MaaS asset being a three-dimensional coordinate.

17. The method of claim 10, wherein the information received by one or more processors was transmitted from the second MaaS asset using a mesh network.

18. A non-transitory computer-readable medium for locating a first Mobility as a Service (“MaaS”) asset, the non-transitory computer-readable medium including instructions that when executed by one or more processors cause the one or more processors to:
receive via a network access device information from a second MaaS asset having an electronic sensing device, the information including a location of the second MaaS asset and an identifier of the at least ono first MaaS asset sensed by the electronic sensing device of the second MaaS asset, the electronic sensing device being a camera capable of visually detecting and sensing the identifier;
determine a location of the first MaaS asset based on the information from the second MaaS asset, the location of the first MaaS asset being a three-dimensional coordinate;
generate an electronic three-dimensional map of an area surrounding the location of the first MaaS asset;
place a MaaS asset indicator on the electronic three-dimensional map, the MaaS asset indicator indicating the location of the first MaaS asset; and
wherein the first MaaS asset and the second MaaS asset are vehicles capable of transporting at least one person or cargo from one location to another.

19. The non-transitory computer-readable medium of claim 18, further comprising instructions that when executed by the one or more processors cause the one or more processors to broadcast the electronic three-dimensional map having the MaaS asset indicator to at least one external device.

20. The non-transitory computer-readable medium of claim 18, wherein the electronic sensing device further includes an RFID reader.
